(19) United States
(12) Patent Application Publication
(10) Pub. No.: US 2024/0086640 A1
(43) Pub. Date: Mar. 14, 2024

(54) METHOD, SYSTEM, AND COMPUTER READABLE STORAGE MEDIA FOR TRANSCRIPT ANALYSIS

(71) Applicant: LEXITAS, INC., Houston, TX (US)

(72) Inventor: Tirthankar GHOSAL, Siliguri (IN)

(73) Assignee: LEXITAS, INC., Houston, TX (US)

(21) Appl. No.: 17/944,653

(22) Filed: Sep. 14, 2022

(51) Int. Cl. G06F 40/30; G06F 16/35; G06F 40/40

(52) U.S. Cl. CPC G06F 40/30; G06F 16/358; G06F 40/40

(57) ABSTRACT

A method, system, and non-transitory computer-readable storage medium for analyzing transcripts includes receiving a first transcript having one or more questions and one or more answers to the one or more questions, ingesting the first transcript into a first transcript data file, the transcript data file based at least in part on the first transcript, using natural language processing to extract transcript data from the first transcript, generating one or more sets of metrics corresponding to the first transcript, the one or more sets of metrics based at least in part on global metadata of the first transcript data file, contextualizing the first transcript using vector space modeling, and executing a contradiction detection assessment based at least in part on the one or more questions and the one or more answers to the one or more questions, using inference modeling and anomalies detection to determine a contradiction score.

### FIELD

This disclosure relates generally to technological advances in the field of Natural Language Processing, with a focus on legal text and dialogue processing.

### BACKGROUND

Natural Language Processing (NLP) describes the ability of a computing device to understand and process human language that is spoken or written. While NLP technology is widely used in many contexts, there exists a gap in its use for analyzing transcripts. Known manual and computer-assisted methods for analyzing transcripts rely on people reviewing transcripts to identify context, connections, and contradictions between answers both within a transcript, and at times across many transcripts of different witnesses for the same case or for collections of related witnesses from different cases. Those methods, however, are time consuming and often involve teams of reviewers who are unable to identify nuanced connections and contradictions in distinct portions of testimony. Accordingly, there is a need for improved technology for transcript analysis that not only accelerates transcript review, but can provide greater insight into context, connections, and contradictions than would be apparent from manual review of transcripts.

### BRIEF DESCRIPTION OF THE DRAWINGS

Example embodiments in accordance with this disclosure will now be described with reference to the attached figures.

FIG. 1 depicts exemplary embodiments of a transcript analyzer system 100 in accordance with this disclosure;

FIG. 2 depicts an exemplary embodiment of a method 200 for analyzing transcripts by a transcript analyzer in accordance with this disclosure;

FIG. 3 presents an exemplary embodiment of a user interface 300 populated with transcripts in accordance with this disclosure;

FIG. 4 presents an exemplary embodiment of a user interface 300 with an expanded actions drop down-menu 410 consistent with this disclosure;

FIG. 5 presents an exemplary embodiment of a transcript upload interface 500 in accordance with this disclosure;

FIG. 6A presents an exemplary embodiment of a transcript group creation interface 600 for creating a new group of transcripts consistent with this disclosure;

FIG. 6B presents an exemplary embodiment of a transcript group interface 650 for navigating and selecting one or more groups of transcripts consistent with this disclosure;

FIG. 7 presents an exemplary embodiment of a question/answer analysis user interface 700 in accordance with this disclosure;

FIG. 8 presents an exemplary embodiment of a thematic analysis user interface 800 in accordance with this disclosure;

FIG. 9 presents an exemplary embodiment of a statistics user interface 900 consistent with this disclosure;

FIG. 10 presents an exemplary embodiment of an expanded statistic user interface 1000 consistent with this disclosure; and

FIG. 11 presents an exemplary embodiment of a contradiction user interface 1100 consistent with this disclosure.

### DETAILED DESCRIPTION

Embodiments disclosed herein improve technology for analyzing transcripts.

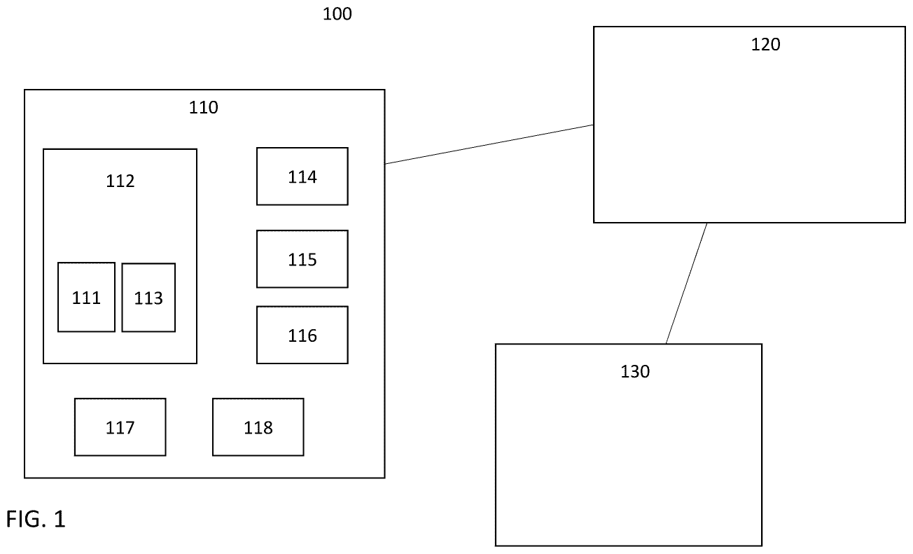

FIG. 1 discloses aspects of exemplary embodiments of a transcript analyzer system 100 in accordance with this disclosure.

In various embodiments, a transcript analyzer system may include a transcript analyzer module 110, an application server 120, and a user system 130.

A transcript analyzer module 110 may include a natural language processing module 112, a memory 114, and a user interface (“UI”) generator 116. Natural language processing module 112 may be based in part on a state of the art processor capable of receiving data files and applying known methods of natural language processing to analyze transcripts. Alternative embodiments may be configured to use utilize off-the-shelf natural language processing capabilities, such as via interacting with the Google Natural Language API. Memory 114 may be any computer readable storage medium, e.g. random access memory (RAM). UI generator 116 may be a state of the art UI generator capable of receiving data from an application server 120 in response to instructions from a user system 130 and transmitting generated UI elements for a transcript analyzer module 110 to user system 130. UI generator 116 may be configured to produce one or more interactive and navigable displays on a user system 130 for transcript analysis management.

In various embodiments, natural language processing module 112 may further include a semantic analyzer module 111 and a contradiction sub module 113. Semantic analyzer module 111 may be trained on a multi-genre natural language inference dataset to make predictions about whether a pair of questions in a transcript is semantically equivalent or not. Semantic analyzer module 111 may further be trained on a question duplication dataset, such as the Quora Question Pair Duplication Dataset, to identify textual similarities between answers or question and answer pairs within a transcript or between answers in two or more transcripts.

In various embodiments, transcript analyzer module 110 may further include a clustering module 115 for multi-level hierarchical clustering of question-answer pairs. Clustering module 115 may utilize a hierarchical DBSCAN clustering algorithm. Clustering module 115 may generate one or more clusters reflecting one or more themes identified in one or more transcripts and may also generate sub-clusters of the one or more clusters.

Transcript analyzer module 110 may further include a query module 117 for executing a search operation for a given query. Query module 117 may extract metadata from one or more transcripts being queried, using clustering module 115, generate one or more clusters corresponding to the query, and use semantic analyzer module 111 to extract similar question/answer pairs and associated metadata.

Transcript analyzer module 110 may include a raw module 118 configured to format data from a transcript data file into an input consumable by clustering module 115.

An application server 120 may be a software system upon which web applications run. In some embodiments, application server 120 may be a hardware device upon which web applications run. Application server 120 may comprise, e.g., web server connectors, computer programming scripts, and data base connectors. Application server 120 is capable of receiving instructions and information from a transcript analyzer module 110 and transmitting the received information to a user system 130 for display, and receiving information from user system 130 and transmitting the received information to transcript analyzer module 110. In various embodiments, an application server 120 may be hosted on a cloud computing framework.

A user system 130 may be, for example, a desktop computer, a laptop computer, a specialized computer server, or an Internet enabled smartphone or tablet. A user system 130 is representative of any electronic device, or combination of electronic devices, capable of receiving information on a user interface and transmitting data files corresponding to transcripts.

While the exemplary embodiments depicted in FIG. 1 show a transcript analyzer module 110, an application server 120, and a user system 130 as being operably connected, it should be noted that this is only one of many embodiments of an appropriate transcript analyzer system 100. In other embodiments, each component of transcript analyzer 100 may be connected via a network. Examples of an appropriate network include, for example, a local area network (“LAN”), a wide area network (“WAN”) such as the Internet, or a combination of the two, and may include wired, wireless, or fiber optic connections.

While the exemplary embodiments depicted in FIG. 1 show a transcript analyzer module 110, an application server 120, and a user system 130 as being separate components, it should be noted that this is only one or many embodiments of an appropriate transcript analyzer system 100. In an alternative embodiment, transcript analyzer module 110 and application server 120 may be housed on a user system 130, if the system is to be deployed on a local computer, for example.

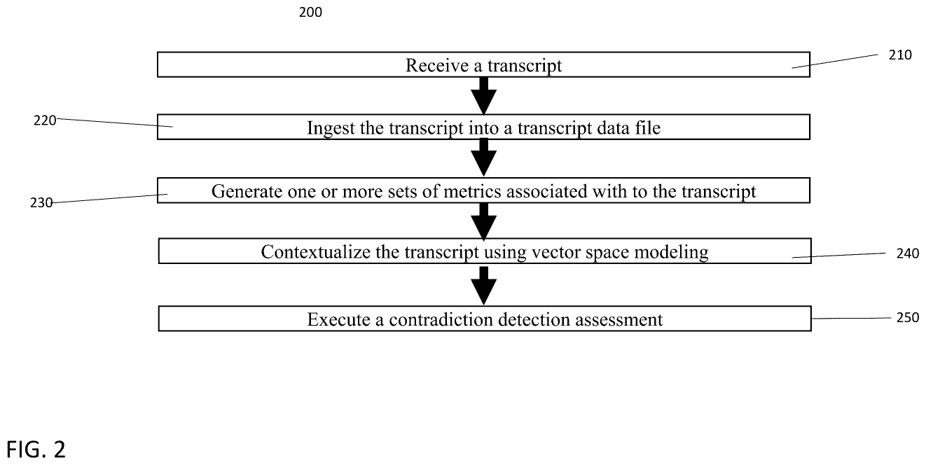

FIG. 2 discloses an exemplary method 200 for analyzing a transcript in accordance with this disclosure.

A method 200 for analyzing a transcript may include a transcript analyzer module, e.g., 110 receiving 210 a transcript. In various embodiments, a transcript received by transcript analyzer module 110 may be in the form of a document file, for example, .pdf, .txt, or .docx. In other embodiments, transcript analyzer module 110 may receive one or more transcripts in the form of an archive or container, such as a .zip file. In some embodiments, one or more transcripts may be received 210 from a user system 130. In other embodiments, one or more transcripts may be received from an external server (not illustrated).

Ingesting 220 the transcript into a transcript data file may include a transcript analyzer module 110 converting a native transcript data type into a transcript data file. In various embodiments, transcript analyzer module 110 may be configured to discard a set of initial pages from the native transcript. A set of initial pages may contain meta-data presented prior to a set of questions and answers contained in a transcript. A set of initial pages may include, e.g., a title page, a read-in page, or a case caption page. Embodiments may also be configured to discard other pages, such instruction or index pages that may be appended to the end of a transcript. A transcript data file may include global metadata, such as a transcript file name, a transcript file size, a date that the transcript data file was uploaded, a date that the transcript data file was updated, and other user applied labels and descriptors. Ingesting the transcript segments the native transcript file into smaller chunks for display on the front end. This improves the efficiency of user queries on the back end.

Ingesting 220 a transcript may further include a transcript analyzer module 110 using a natural language processor, e.g., 112, to identify one or more questions and one or more answers by parsing a transcript data file without a set of initial pages. Using natural language processing, transcript analyzer module 110 may identify one or more question indicators in the transcript data file. A question indicator may be a question mark, a sentence structure, or a common question term like why, what, and who. Transcript analyzer module 110 may further identify one or more answer indicators using natural language processing. An answer indicator may include language in common with a preceding question, a sentence structure, and a proximity to a question.

Ingesting 220 a transcript may further include a transcript analyzer module 110 using a natural language processing module, e.g., 112, to identify one or more question and answer pairs. Transcript analyzer module 110 may detect a question and its corresponding answer by using natural language processing to identify common language indicators. These common language indicators may include similar wording, complimentary sentence structure, or proximity. Once identified, a transcript analyzer 110 may label the one or more question and answer pairs by assigning data identifiers to each pair of the one or more question and answer pairs. Examples of data identifiers include, but are not limited to, page number, line number, text of the question, text of the answer, a person who asked the question, a person who provided the answer, and a transcript file name.

Ingesting 220 a transcript may further include a transcript analyzer module 110 using a natural language processing module 112 to perform a syntactic analysis. In various embodiments, natural language processing module 112 may use natural language processing to extract linguistic information by, for example, calculating an aggregate word count per question for a person or an aggregate word count per answer for a person, or preparing an objection report analyzing one or more objection trends identified in the transcript.

Ingesting 220 a transcript may further include a transcript analyzer module 110 using a natural language processing module, e.g., 112, to detect one or more themes common throughout a transcript data file, a frequency of objections, an average number of words per question, an average number of words per answer, and a number of times a question (optionally an identical question or a similar question) is repeated by one or more speakers asking the question.

Ingesting 220 the transcript may further include a transcript analyzer module 110 storing the transcript data file in a transcript database. In various embodiments, a transcript database may include one or more transcript data files and be stored on a memory, e.g., 114. In another embodiment, a transcript database may be stored on an external memory. In some embodiments, transcript analyzer module 110 may store the transcript data file in a master transcript database in which all transcripts stored in a memory, e.g., 114 are contained. In other embodiments, transcript analyzer module 110 may store a transcript data file in a group transcript database in which a subset of transcripts stored in a memory, e.g., 114 is contained.

While the method 200 depicted in FIG. 2 is described as being performed by a transcript analyzer module, e.g., 110, it should be noted that the steps of method 200 may be performed in alternative embodiments by a user system, e.g., 130.

Ingesting 220 the transcript and converting the transcript to a transcript data file up front improves the speed at which a transcript analyzer module, e.g., 110 may provide one or more search results to a user system, e.g., 130. It may also reduce the memory and processor resource usage, allowing implementation of embodiments disclosed herein on a broader range of computing devices.

Generating 230 one or more sets of metrics associated with the transcript may include a transcript analyzer, e.g., 110, identifying metadata of the transcript. One or more sets of metrics may be presented in any form consistent with a user interface element, including, by way of non-limiting examples and as shown in later figures, a list, e.g., 720, a graphical representation, e.g., 910, 1020, a plurality of cluster-bubbles, e.g., theme bubbles or clusters 810, and a contradiction report, e.g., 1110. One or more sets of metrics may include, for example, a number of speakers in the transcript, a number of questions and a number of answers, and global metadata, such as the date of the transcript and the number of words in the transcript.

In some embodiments, a transcript analyzer module, e.g., 110 may detect one or more themes by identifying a frequency of one or more words included in one or more questions and one or more answers. Transcript analyzer module 110 may further detect one or more themes by identifying an abstraction of one or more concepts used in a transcript, using natural language processing capabilities of a natural language processor, e.g., 112. In additional embodiments, transcript analyzer module 110 may detect one or more themes for a plurality of transcripts. A transcript analyzer module 110 may detect one or more themes by using concept-based clustering to build one or more word clusters and identify patterns based on syntactic patterns and entity analysis. This may assist a user with, for example, identifying which witnesses disproportionately focused on specific people, places, objects, and the like.

Contextualizing 240 the transcript may include transcript analyzer module 110 using vector space modeling to convert the text of the transcript into vectors (array/string of numbers). In various embodiments, a dimension of the vector space modeling may be on the order of magnitude of 10³, such as 2¹⁰ or 2¹¹ dimensions. In other embodiments, a dimension of the vector space modeling may be on the order of magnitude of 10² such as 2⁹ or 2⁸ dimensions. In various embodiments, vector space modeling may be at least in part based on Spatial Vector Modeling techniques trained with datasets, for example, Multi-Genre Natural Language Inference (MNLI) and Quora Question Pair Duplication (QQPD) datasets.

Executing 250 a contradiction detection assessment may include a transcript analyzer, e.g., 110 determining a contradiction score for one or more question/answer pairs. In various embodiments, a contradiction score may be determined using an algorithm that factors in a degree of dissimilarity of one or more questions, a degree of dissimilarity of one or more corresponding answers, a length of the answer. A contradiction score may assign a numerical value reflecting a level of contradiction between a one or more answer to one or more similar questions. A contradiction score may further estimate a likelihood of contradictory answers being provided in one or more related questions.

In various embodiments, executing 250 a contradiction detection assessment includes a transcript analyzer using a contradiction detection algorithm to determine a contradiction score. A contradiction detection algorithm may use inference modeling, language anomalies detection, and vector space modeling to determine a contradiction score. A transcript analyzer 110 may use dynamic training to run an ongoing data model that learns over time, improving the accuracy of the contradiction detection algorithm. In various embodiments, a transcript analyzer 110 may further receive user feedback to improve the accuracy of the contradiction detection by refining the data model. In various embodiments, a transcript analyzer 110 may use an entailment engine to run an entailment algorithm that is factored into a contradiction algorithm. Alternatively, a transcript analyzer 110 may itself run an entailment algorithm that is factored into a contradiction algorithm.

In various embodiments, a user inference modeling may be at least in part based on available inference modeling, such as the RoBERTa model trained on the Stanford Natural Language Inference (SNLI) dataset. In various embodiments, language anomalies detection may be at least in part based on available conversational anomalies/inconsistencies datasets, such as DECODE. Further training of these models may include using vector space modeling and entailment to identify inconsistencies and assign a contradiction score.

Executing 250 a contradiction detection assessment may include a transcript analyzer module 110 using text-based anomaly detection to generate a contradiction report, e.g., 1110, that includes anomaly-related data for the corresponding transcript. Anomaly-related data may include an identified anomaly and a speaker associated with the identified anomaly. In various embodiments, transcript analyzer module 110 may analyze a transcript data file to identify one or more inconsistencies in one or more answers to one or more questions. In such an embodiment, transcript analyzer module 110 may use a natural language processing module, e.g., 112, to compare questions with one or more similarities to a corresponding one or more answers having one or more dissimilarities. Natural language processing module 112 may use natural language processing to group a plurality of questions that ask about a same issue but use synonymous words, such as a question asking how much money a witness makes and a question asking what a witness is paid, and identify one or more dissimilarities in a plurality of answers. This may assist in identifying inconsistencies in testimony.

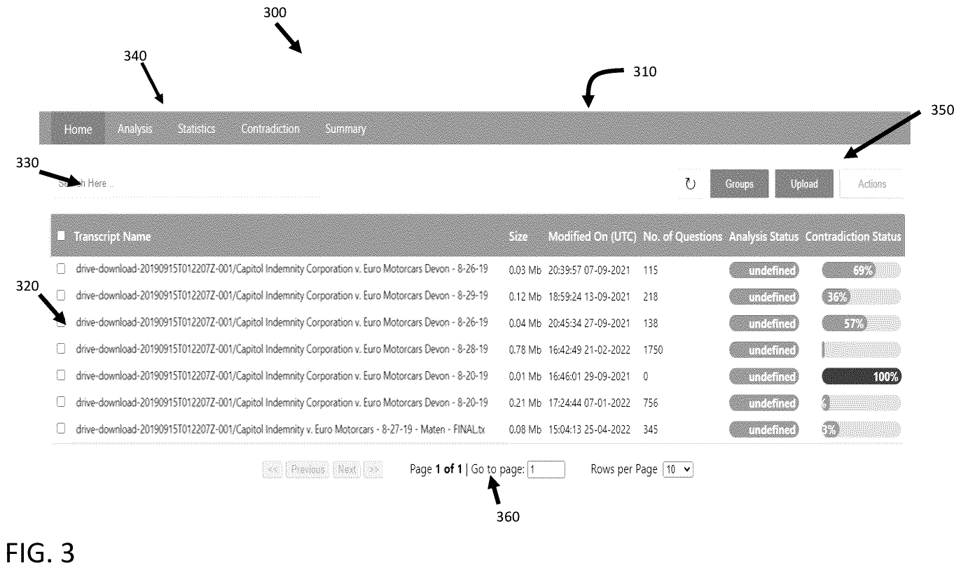

FIG. 3 is an exemplary display 310, generated by a transcript analysis system 100 and displayed on a user system 130, of a transcript analysis user interface 300 consistent with this disclosure. In various embodiments, a display 310 includes a transcript library window 320, a search bar 330, a menu toolbar 340, one or more action buttons 350, and one or more navigation tools 360.

A transcript library window 320 may include a list of transcripts, stored on a memory e.g., 114. This list may include a name of a transcript data file, a size of the transcript data file, a last date modified, a number of questions, and a contradiction status. In some embodiments, a contradiction status may indicate whether transcript analyzer module 110 has completed a contradiction analysis of a transcript data file and may be pending or ready. In an embodiment in which a contradiction analysis of a transcript data file is ready, a user may select a contradiction status indicator, e.g., “View,” to view contradiction analysis data of the transcript data file. In various embodiments, a transcript library window 320 may include one or more pages of transcripts in a list of transcripts.

A search bar 330 may allow a user to execute a keyword search of one or more transcript data files in a transcript library window 320.

A menu toolbar 340 may include at least one heading button allowing a user to select one or more heading buttons to navigate to a corresponding page or display of a user interface of transcript analysis module 110. In various embodiments, a menu toolbar 340 may include “Home,” “Analysis,” “Statistics,” and “Contradiction.” In such embodiments, transcript analyzer module 110 may, in response to an input from a user on a user system 130, navigate the user to a corresponding page or display of transcript analysis user interface 300. For example, a user input selecting “Home” may navigate a user to a home page, e.g., display 310, a user input selecting “Analysis” may navigate a user to an analysis user interface, e.g., 700, 800, a user input selecting “Statistics” may navigate a user to a statistics user interface, e.g., 900, 1000, and a user input selecting “Contradiction” may navigate as user to a contradiction user interface, e.g., 1100. These pages or user interfaces may be, for example, web pages or displays within an app or other software program. Embodiments may optionally display multiple pages simultaneously on different parts of a screen, or across multiple screens.

One or more action buttons 350 may include at least one button allowing a user to perform a corresponding action. In various embodiments, at least one button may include “Groups,” “Upload,” “Actions,” and “Undo” (represented by a circular arrow). In such embodiments, a transcript analyzer module 110 may, in response to an input from a user on a user system 130, generate a corresponding action page, e.g., 400, 500, 600 of transcript analysis user interface 300. For example a user input selecting “Groups” may generate a transcript group creation interface, e.g., 600 allowing a user to view and create one or more groups of transcripts, a user input selecting “Upload” may generate a transcript upload page, e.g., 500 allowing a user to upload one or more transcripts to transcript analyzer module 110, a user input selecting “Actions” may generate an action drop down menu, e.g., 410 displaying one or more action buttons allowing a user to perform a corresponding action, and an “Undo” button. e.g., a circular arrow, allowing a user to undo a previous action.

One or more navigation tools 360 may display navigation information and include at least one button allowing a user to perform a corresponding navigation action. In various embodiments, navigation information may include a page number and a number of rows displayed in a transcript library window, e.g., 320. In various embodiments, a corresponding navigation action may allow a user to, for example, navigate to a next page of transcript library window 320, a previous page of transcript library window 320, a last page of transcript library window 320, or a first page of transcript library window 320. A corresponding navigation action may further allow a user to input a page number and navigate to that page and to select a number of rows of transcripts displayed per page of transcript library window 320.

Exemplary display 310 may include additional information relating to an uploaded transcript. For example, exemplary display 310 may include information corresponding to whether a particular transcript has been analyzed by transcript analyzer module 110. In exemplary display 310, this is denoted by the column heading “Analysis Status.” Exemplary display 310 may also include information corresponding to whether a contradiction detection assessment has been executed for a particular transcript. In exemplary display 310, this is denoted by the column heading “Contradiction Status” and a corresponding percentage value reflects the portion of the transcript for which a contradiction detection assessment has been executed.

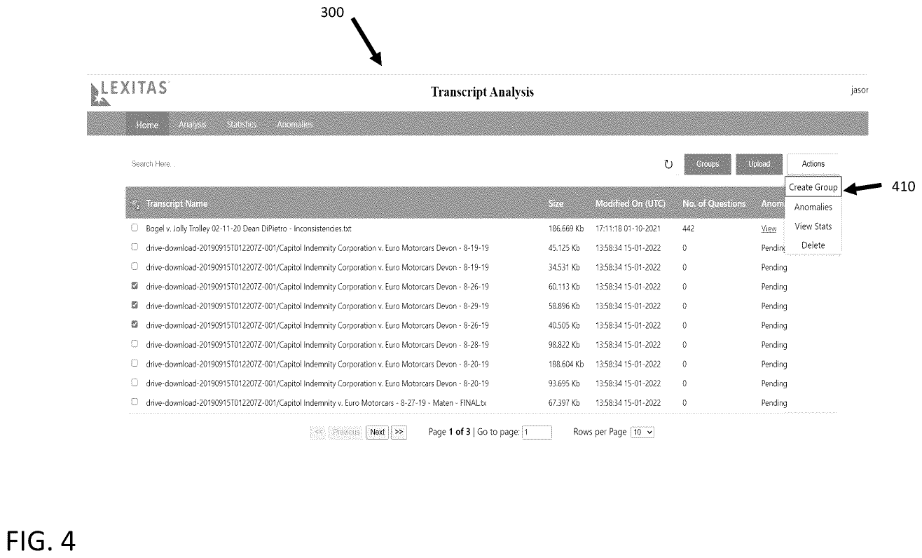

As seen in FIG. 4 a user interface 300 may include an actions drop down menu 410. In various embodiments, a transcript analyzer module, e.g., 110 may generate an expanded actions drop down menu 410 in response to a user input in a user system, e.g., 130. In such embodiments, actions drop down menu 410 may include at least one button allowing a user to perform a corresponding action. At least one button may include, but is not limited to, a “Create Group” button, a “Contradiction” button, a “View Statistics” button, and a “Delete” button. In response to a user input selecting a “Create Group” button, a transcript analyzer module, e.g., 110 may create a group of transcripts from one or more transcripts selected in a transcript library window, e.g., 310. In response to a user input selecting “Contradiction,” transcript analyzer module, e.g., 110 may perform a contradiction analysis of one or more transcripts selected in a transcript library window, e.g., 310. In response to a user input selecting “View Statistics,” a transcript analyzer, e.g., 110 may perform a statistical analysis of one or more transcript selected in a transcript library window, e.g., 110. In response to a user input selecting “Delete,” a transcript analyzer module, e.g., 110 may delete one or more transcripts selected in a transcript library window, e.g., 110. In various embodiments, transcript analyzer 110 may delete one or more transcripts from memory 114.

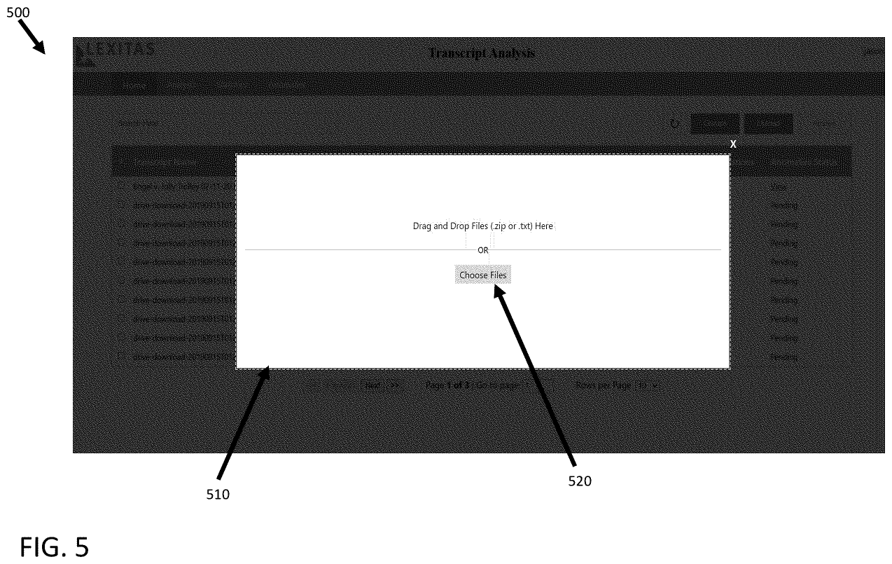

FIG. 5 is an exemplary display of a transcript upload interface 500 consistent with this disclosure. In various embodiments, a transcript upload interface 500 may include a transcript upload window 510 that enables a user to upload one or more transcripts in a transcript analyzer module 110. To upload a transcript to a transcript analyzer, a user may drag and drop one or more transcripts on a user system 130 into transcript upload window 510. Alternatively, a user may select a “Choose Files” button 520 in order to select one or more transcripts from a user system 130 to upload to transcript analyzer module 110. A transcript analyzer module 110, in response to a user uploading one or more transcripts, may receive 210 one or more transcripts and begin method 200.

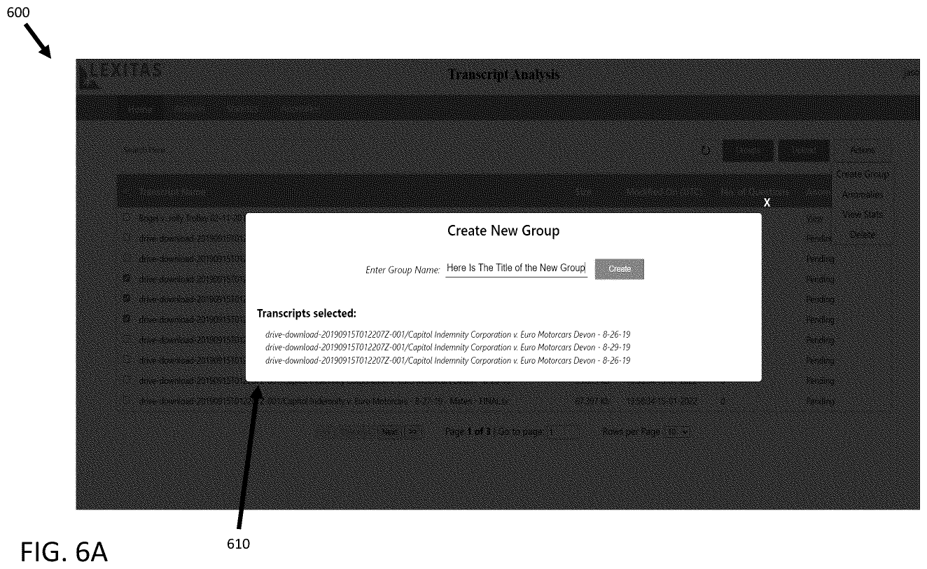

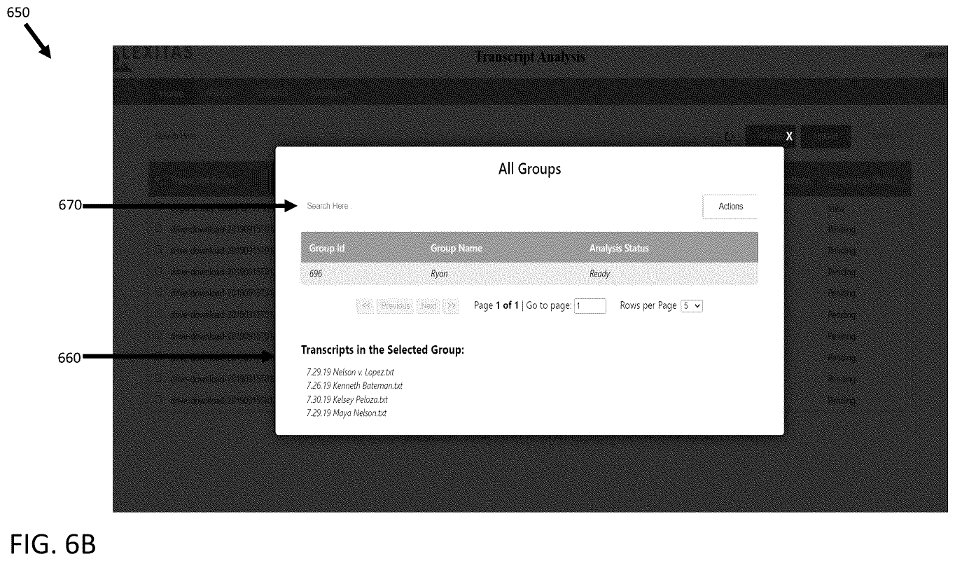

FIG. 6A is an exemplary display of a transcript group creation interface 600 for creating a group of transcripts consistent with this disclosure. In various embodiments, a transcript group creation interface 600 may include a group creation window 610. Group creation window 610 may display a list of a plurality of transcripts selected in a transcript library window, e.g., 310 that comprise the group of transcripts, a group name determined by a user, and a group creation button 620 for creating the group of transcripts. In various embodiments, in response to a user input selecting a group creation button 620, a transcript analyzer module 110 may generate by a UI generator 116 a transcript group interface, e.g., 650.

FIG. 6B presents an exemplary display of a transcript group interface 650 for navigating and selecting one or more groups of transcripts. In various embodiments, a transcript group interface 650 may include a group library window 660 displaying one or more groups of transcripts. Group library window 660 may display information about the one or more groups of transcripts, including but not limited to, Group ID, Group Name, and Analysis Status. In various embodiments, a transcript analyzer module 110 may analyze one or more transcripts in a group of transcripts in response to a creation of the group of transcripts. Group window 660 may display the Analysis Status, i.e. whether the group is Ready (analysis complete) or whether the group is Pending (analysis not complete).

Group window 660 may display, by a transcript analyzer module 110, a list of a plurality of transcripts in a selected group of transcripts in response to a user input in a user system 130. Group library window may include a search bar 670 for searching one or more groups displayed in group library window 660. In various embodiments, one or more groups are stored in a memory, e.g., 114.

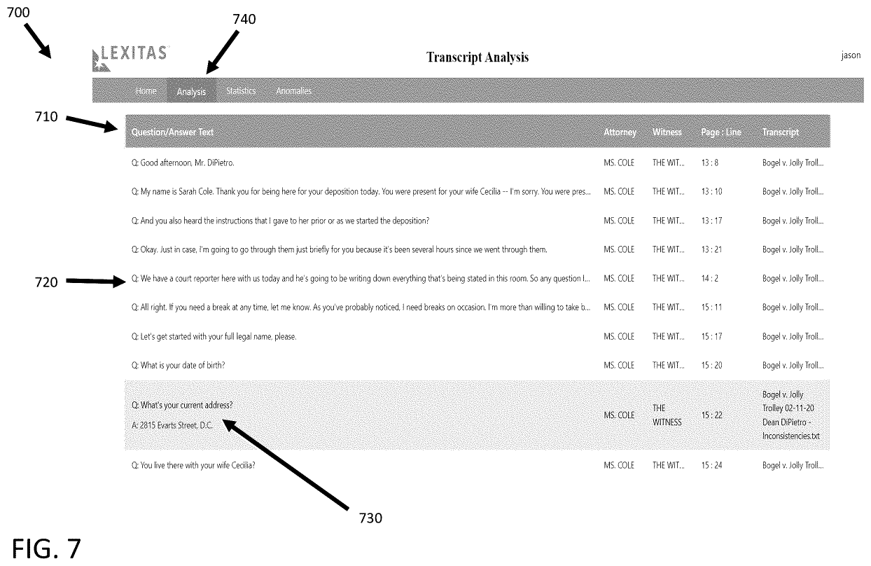

As shown in FIG. 7, a question/answer analysis interface 700 may include a question/answer library window 710 and a menu toolbar, e.g., 340, 740, 840, 940, 1040, 1120. A question/answer library window 710 may include a list of one or more questions from one or more transcripts and question/answer information corresponding to each of the one or more questions. Question/answer information may include, but is not limited to, a text of the question, a name of an attorney who asked the question, a name of a witness who gave an answer to the question, a page number and a line number corresponding to a location of the question in the transcript, and a name of the corresponding transcript in which the question is found. Question/answer library window 710 may further include one or more unexpanded questions 720 and one or more expanded question 730. Expanded question 730 may include a question and a corresponding answer to the question. Unexpanded question 720 may include a question without a corresponding answer.

While this particular embodiment of a question/answer analysis interface 700 includes one or more questions from one transcript, it should be appreciated that a question/answer analysis interface 700 may include questions from more than one transcript. A question/answer analysis interface 700 may, for example, correspond to a group of one or more transcripts. In such embodiments, a question/answer analysis interface 700 may display questions from one or more transcripts in the group of transcripts.

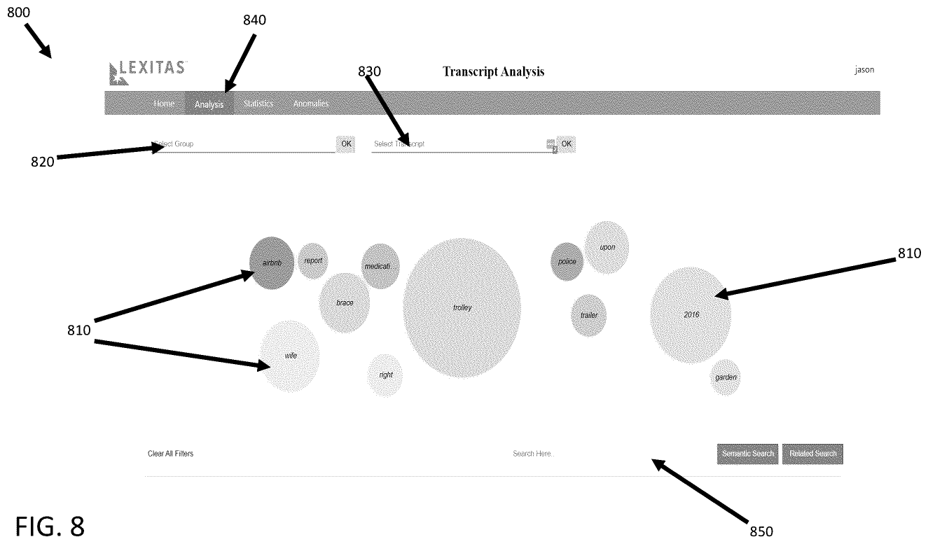

FIG. 8 is an exemplary display of a thematic analysis interface 800 consistent with this disclosure. As shown in FIG. 8, a thematic analysis interface 800 may include at least one theme bubbles or clusters 810, a group search bar 820 for searching for one or more groups of one or more transcripts, a transcript search bar 830 for searching for one or more transcripts, a menu toolbar, e.g., 340, 740, 840, 940, 1040, 1120 and a semantic search bar 850.

At least one theme bubble or cluster 810 may indicate a set of one or more themes determined by a natural language processor, e.g., 112 using concept based clustering. In some embodiments, natural language processor 112 may use concept based clustering on one transcript and determine at least one theme bubble or cluster 810 therefrom. In other embodiments, natural language processor 112 may use concept based clustering on a plurality of transcripts and determine at least one theme bubble therefrom. Concept based clustering may include identifying and grouping one or more question and answer pairs that have a common theme or keyword. In some embodiments, at least one theme bubble or cluster 810 may be more than one size, where a size of a theme bubble or cluster 810 indicates a frequency with which a theme was identified in a one or more transcripts.

In various embodiments, there may be one or more levels of theme bubbles or clusters 810. For example, a user may select a theme bubble or cluster, e.g. 810, corresponding to a parent theme in order to drill down into one or more additional theme bubbles or clusters that correspond to one or more sub-themes of the parent theme.

Semantic search bar 850 may use semantic similarity data models to compare user-generated questions with questions in a database. The comparison may be performed using vector space modeling techniques trained with datasets built using, for example, Multi-Genre Natural Language Inference (MNLI) and Quora Question Pair Duplication (QQPD) datasets

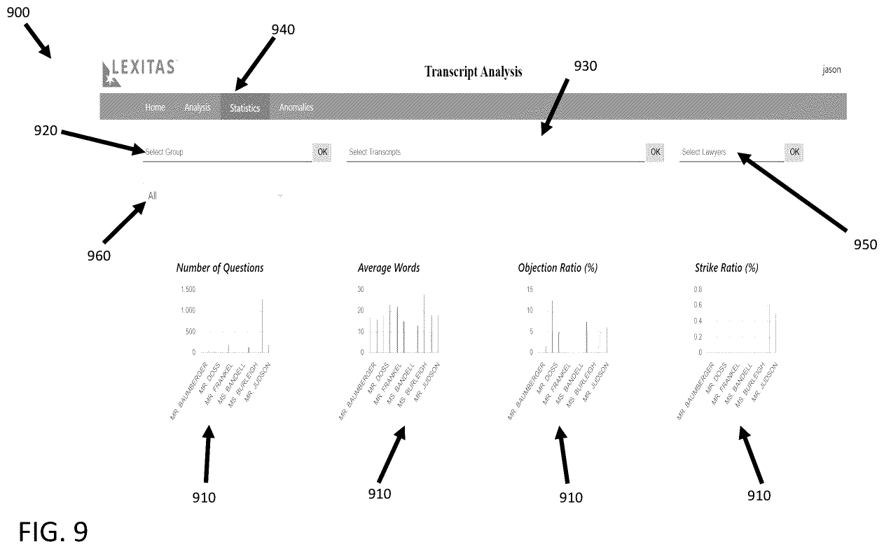

FIG. 9 presents an exemplary display of a statistics user interface 900 consistent with this disclosure. A statistics page 900 may include one or more statistic display window thumbnails 910, a group search bar 920 for searching one or more groups of one or more transcripts, a transcript search bar 930 for searching for one or more transcripts, a menu toolbar, e.g., 340, 740, 840, 940, 1040, 1120, a lawyers search bar 950 for search for one or more lawyers in one or more transcripts, and a statistics selection menu 960.

One or more statistic display window thumbnails 910 may display one or more statistic reports corresponding to one or more key metrics of one or more transcripts. In various embodiments, a statistic display window thumbnail 910 may display a bar graph of a number of questions asked by one or more persons in one or more transcripts. In other embodiments, statistic display window thumbnail 910 may display key metrics such as an average number of words per question, an objection ratio (e.g., a number of objections raised per question), or a strike ratio (e.g., a number of questions stricken per total number of questions). In response to a user input from a user system 130 selecting a statistics display window thumbnail, a transcript analyzer module 110 may navigate a user to an expanded statistics user interface, e.g., 1000.

A statistics selection menu 960 may be a drop down menu including one or more statistics from which a user may select such that a transcript analyzer module 110 display one or more sets of analytical data from the transcript. In various embodiments, one or more reports may be in the form of statistics display window thumbnail 910.

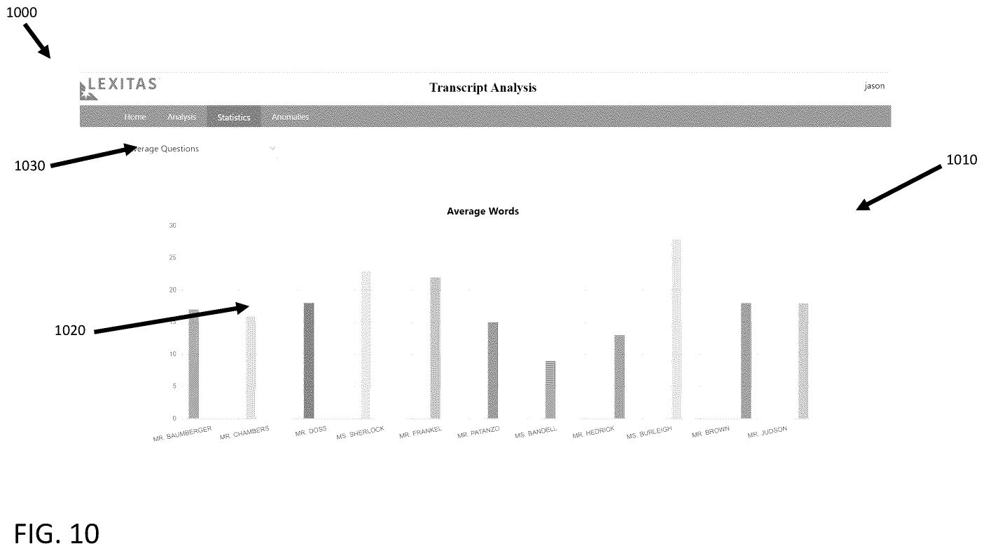

FIG. 10 is an exemplary display of an expanded statistics user interface 1000 consistent with this disclosure. An expanded statistics user interface 1000 may include a statistics display window 1010, a chart 1020, a statistics selection menu 1030, and a menu toolbar, e.g., 340, 740, 840, 940, 1040, 1120.

A statistics display window 1010 may include one or more reports corresponding to one or more sets of analytical data generated by a transcript analyzer 110. In various embodiments, a report may include a chart 1020 conveying one or more sets of key metric data. A chart 1020 may be, e.g., a bar graph, a line graph, a Venn diagram, a table, or a heatmap.

A statistics selection menu 1030 may be a drop down menu including one or more statistics from which a user may select. In various embodiments, one or more reports may be in the form of statistics display window 1010.

In various embodiments, an expanded statistics user interface may include a set of statistics corresponding to a particular lawyer chosen, for example, in lawyer search bar 960. This set of statistics may correspond to statistics extracted from one or more transcripts associated with the particular lawyer. A summary may be provided aggregating statistics associated with the particular lawyer used for lawyer development. An expanded statistics user interface may also include a set of statistics corresponding to a particular group of transcripts chosen, for example, in group search bar 920. An expanded statistics user interface may further include a set of statistics corresponding to a particular transcript chosen, for example, in transcript search bar 930.

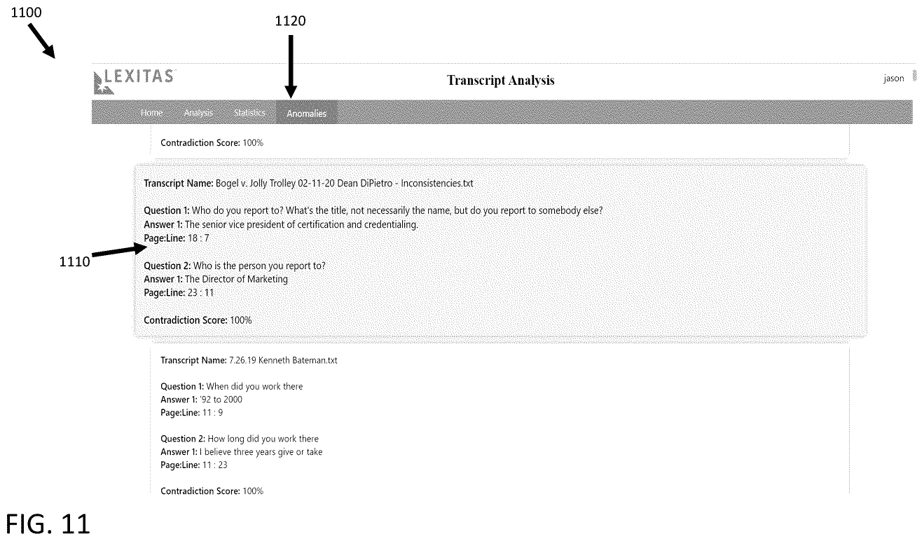

FIG. 11 presents an exemplary display of a contradiction user interface 1100 consistent with this disclosure. A contradiction user interface 1100 may include at least one contradiction report 1110, a menu toolbar, e.g., 340, 740, 840, 940, 1040, 1120. At least one contradiction report 1110 may identify thematic inconsistences and logical inconsistencies in one or more transcripts. For example, at least one contradiction report 1110 may identify instances where an answer to one question contradicts an answer to a second question. In such embodiments, contradiction report 1110 may include a name of the transcript, a first question and first answer to the first question, a page and line number of the first question and the first answer, a second question and a contradictory answer, a page and line number of the second question and the contradictory answer, and a contradiction score.

A user may select a transcript from transcript search bar 1130 to view a contradiction report. In various embodiments, contradiction report 1110 may suggest one or more questions based on the contradictory answers. In various embodiments, a suggested answer may be topically or semantically related to the contradictory answer. In various embodiments, a contradiction user interface 1100 may further include a user feedback option 1120 where a user may agree or disagree with an anomaly identified. User feedback option 1120 may be, but is not limited to, a button or a fillable form. The one or more suggested questions may be ranked by a probability of a contradictory answer resulting from the suggested question.

We claim:

1. A method for analyzing, by a computing device, one or more transcripts, the method comprising:
receiving, by the computing device, a first transcript comprising at least one or more questions and one or more answers to the one or more questions;
ingesting, by the computing device, the first transcript into a first transcript data file, the transcript data file based at least in part on the first transcript, the computing device using natural language processing to extract transcript data from the first transcript;
generating, by the computing device, one or more sets of metrics corresponding to the first transcript, the one or more sets of metrics based at least in part on global metadata of the first transcript data file;
contextualizing, by the computing device, the first transcript using vector space modeling; and
executing, by the computing device, a contradiction detection assessment, based at least in part on the one or more questions and the one or more answers to the one or more questions, using inference modeling and anomalies detection to determine a contradiction score.

2. The method of claim 1, further comprising storing, but the computing device, a first transcript data file in a transcript database.

3. The method of claim 1, wherein the contradiction detection assessment comprises a dynamic learning model.

4. The method of claim 1, wherein receiving a first transcript further comprises receiving a plurality of transcripts.

5. The method of claim 1, further comprising generating, by the computing device and in response to a query, a semantic search result, wherein the query comprises a query question, and wherein the semantic search result comprises a set of one or more questions that are similar to a query question.

6. The method of claim 1, wherein ingesting the transcript further comprises clustering, by the computing device, one or more semantically similar questions of the one or more questions, wherein one or more clusters represent a theme common to the one or more semantically similar questions.

7. The method of claim 6, wherein the one or more clusters representing a parent theme is drilled-down into one or more sub-clusters representing one or more subthemes of the parent theme.

8. The method of claim 1, wherein a dimension of the vector space modeling is 1,000.

9. The method of claim 1, further comprising generating, by the computing device, one or more suggested questions, wherein the suggested questions are configured to reduce the contradiction score.

10. The method of claim 1, wherein ingesting the first transcript further comprises parsing the first transcript to identify metadata and storing the metadata in a database associated with the transcript data file.

11. A system for analyzing one or more transcripts, wherein the system comprises a computing device configured to:
receive the first transcript comprising at least one or more questions and one or more answers to the one or more questions;
ingest the first transcript into a first transcript data file, the transcript data file based at least in part on the first transcript, the computing device using natural language processing to extract transcript data from the first transcript;
generate one or more sets of metrics corresponding to the first transcript, the one or more sets of metrics based at least in part on global metadata of the first transcript data file;
contextualize the first transcript using vector space modeling; and
execute a contradiction detection assessment, based at least in part on the one or more questions and the one or more answers to the one or more questions, using inference modeling and anomalies detection to determine a contradiction score.

12. The system according to claim 11, further comprising generating, by the computing device and in response to a query, a semantic search result, wherein the query comprises a query question, and wherein the semantic search result comprises a set of one or more questions that are similar to a query question.

13. The system according to claim 11, wherein ingesting the first transcript further comprises parsing the first transcript to identify metadata and storing the metadata in a database associated with the transcript data file.

14. The system according to claim 11, wherein ingesting the transcript further comprises clustering, by the computing device, one or more semantically similar questions of the one or more questions, wherein one or more clusters represent a theme common to the one or more semantically similar questions.

15. The system according to claim 11, the one or more clusters representing a theme is drilled-down into one or more sub-clusters representing one or more subthemes of the theme.

16. A non-transitory computer-readable storage medium having computer-executable instructions stored thereon for analyzing one or more transcripts, wherein executing the computer-executable instructions on a computing device causes the computing device to:
receiving, by the computing device a first transcript, the first transcript comprising at least one or more questions and one or more answers to the one or more questions;
ingesting, by the computing device, the first transcript into a first transcript data file, the transcript data file based at least in part on the first transcript, the computing device using natural language processing to extract transcript data from the first transcript;
generating, by the computing device, one or more sets of metrics corresponding to the first transcript, the one or more sets of metrics based at least in part on global metadata of the first transcript data file;
contextualizing, by the computing device, the first transcript using vector space modeling; and
executing, by the computing device, a contradiction detection assessment, based at least in part on the one or more questions and the one or more answers to the one or more questions, using inference modeling and anomalies detection to determine a contradiction score.

17. The non-transitory computer-readable storage medium according to claim 16, further comprising generating, by the computing device and in response to a query, a semantic search result, wherein the query comprises a query question, and wherein the semantic search result comprises a set of one or more questions that are similar to a query question.

18. The non-transitory computer-readable storage medium according to claim 16, wherein ingesting the first transcript further comprises parsing the first transcript to identify metadata and storing the metadata in a database associated with the transcript data file.

19. The non-transitory computer-readable storage medium according to claim 16, wherein ingesting the transcript further comprises clustering, by the computing device, one or more semantically similar questions of the one or more questions, wherein one or more clusters represent a theme common to the one or more semantically similar questions.

20. The non-transitory computer-readable storage medium according to claim 16, the one or more clusters representing a theme is drilled-down into one or more sub-clusters representing one or more subthemes of the theme.
